(19) United States
(12) Patent Application Publication
(10) Pub. No.: US 2016/0365057 A1
(43) Pub. Date: Dec. 15, 2016

(54) LIQUID CRYSTAL DISPLAY PANEL AND DRIVING METHOD THEREOF

(71) Applicant: SHENZHEN CHINA STAR OPTOELECTRONICS TECHNOLOGY CO., LTD., Shenzhen (CN)

(72) Inventors: Dekang ZENG, Shenzhen (CN); Dongsheng GUO, Shenzhen (CN)

(73) Assignee: Shenzhen China Star Optoelectronics Technology Co. , Ltd., Shenzhen Guangdong (CN)

(21) Appl. No.: 14/417,391

(22) PCT Filed: Dec. 30, 2014
(86) PCT No.: PCT/CN2014/095574

§ 371 Date: May 20, 2016

(30) Foreign Application Priority Data
Nov. 20, 2014 (CN) 201410667208

(51) Int. Cl. G09G 3/36; G02F 1/1368

(52) U.S. Cl. CPC G09G 3/3688; G02F 1/1368; G09G 3/3696; G09G 2320/0247; G09G 2310/08; G09G 2320/0242; G09G 2310/027; G09G 2300/0452; G09G 2310/0251; G09G 2310/06; G09G 2320/0233; G02F 1/136286

(57) ABSTRACT

A liquid crystal display panel and a method for driving the liquid crystal display panel are disclosed, said liquid crystal display panel comprising: a source driver; a gate driver; a pixel array, electrically connected between said source driver and said gate driver, and used for displaying an image according to said data signal and said gate signal; and a chamfering circuit, electrically connected with said gate driver, and used for providing said chamfering voltage. The chamfering circuit is configured to reduce a direct voltage received therein to a value of the chamfering voltage within a set time period, so as to avoid a flicker of the image and maintain a uniformity of said liquid crystal display panel in each region thereof.

### CROSS REFERENCE TO RELATED APPLICATION

The present application claims benefit of Chinese patent application CN 201410667208.9, entitled “Liquid Crystal Display Panel and Driving Method Thereof” and filed on Nov. 20, 2014, which is incorporated herein by reference.

### FIELD OF THE INVENTION

The present disclosure relates to the technical field of liquid crystal display, and particularly to a liquid crystal display panel and a method for driving the liquid crystal display panel.

### BACKGROUND OF THE INVENTION

In order to satisfy people's requirements of high speed, high performance, as well as light and thin on electronic products, all kinds of electronic components are developing towards miniaturization. A variety of portable electronic devices have become the mainstream gradually. The liquid crystal display panels, which have many desirable characteristics, such as zero-radiation, are widely used currently as the image display panels for portable electronic devices.

In general, the liquid crystal display panel comprises scanning lines and data lines, wherein the data lines are driven by a source driver, and the scanning lines are driven by a gate driver. In the traditional large sized liquid crystal display panel, since the signal lines from the source driver to the left end or the right end of the liquid crystal display panel are longer than the signal lines from the source driver to the middle part of the panel, the resistances of the Wire on Arrays (WOAs) of the data lines in the fanout region of the panel would be different from one another to a large extent. The resistance difference would result in a poor display effect of the panel, and thus the display quality would be affected.

FIG. 1 schematically shows a liquid crystal display panel with Tri-Gate driving structure in the prior art. Reference can be made to FIG. 1, the liquid crystal display panel comprises a plurality of pixel units arranged in an array, wherein each pixel unit P comprises sub pixels R, G, and B (see FIG. 2) arranged along a column direction in sequence, and the sub pixels R, G, and B are electrically connected with corresponding scanning lines (such as G1-G6 in FIG. 2) and data lines (such as D1-D5 in FIG. 2) through corresponding switching elements. With the above driving structure, for each pixel unit there are only one data line and three scanning lines. That is to say, the data signal of each pixel unit is transmitted through one data line, and the signal used for turning on the switching element of each pixel is transmitted through three scanning lines in sequence. In this case, the complete display of each pixel unit can be realized, the number of the source drivers can be reduced, and thus the cost of the liquid crystal display panel can be saved.

However, with FIG. 1 as an example, if there is only one source driver in the panel, the resistances of the WOAs of the data lines in the fanout region of the panel would be different from one another to a large extent. As shown in FIG. 1, since the distance L 1 from the source driver to the WOAs of the left end or the right end of the panel is much larger than the distance L2 from the source driver to the middle part of the panel, the total resistance of the WOAs of the data lines at the left end or the right end of the panel can amount to 5 KΩ-7 KΩ, while the resistance of the WOAs in the middle part of the panel is only 300Ω-500Ω. In this case, the high resistance of the WOAs would result in serious RC delay effect when the data lines are transmitting data signals, and the charging speed of the pixels at the left and right ends of the liquid crystal display panel would lag behind the charging speed of the pixels at the middle part of the panel significantly. The uneven charging speed of the pixels in the panel would result in the color shift phenomena of the image displayed in the panel, and thus the display quality thereof would be affected.

### SUMMARY OF THE INVENTION

One of the technical problems to be solved by the present disclosure is to provide a liquid crystal display panel which can ease or eliminate the color shift phenomena. In addition, the present disclosure further provides a method for driving the liquid crystal display panel.

1) In order to solve the aforesaid technical problem, the embodiment of the present disclosure first provides a liquid crystal display panel, comprising: a source driver, used for providing a data signal; a gate driver, used for providing a gate signal according to a chamfering voltage; a pixel array, electrically connected between said source driver and said gate driver, and used for displaying an image according to said data signal and said gate signal; a chamfering circuit, electrically connected with said gate driver, and used for providing said chamfering voltage, wherein said chamfering circuit is configured to reduce a direct voltage received therein to a value of the chamfering voltage within a set time, so as to avoid a flicker of the image and maintain a uniformity of said liquid crystal display panel in each region thereof.

2) In one preferred embodiment of item 1) of the present disclosure, said chamfering circuit comprises: a direct voltage input end; a chamfering voltage output end; a first switching circuit, which is connected between said direct voltage input end and said chamfering voltage output end, and can be selectively turned on under a control of a first time sequence signal to selectively transmit a direct voltage received by said direct voltage input end to said chamfering voltage output end; a second switching circuit, which can be selectively turned on under a control of a second time sequence signal, said second time sequence signal and said first time sequence signal being pulse voltage signals with opposite polarities; a discharge circuit, which is connected between said second switching circuit and said chamfering voltage output end, and can be used for reducing a direct voltage transmitted to said chamfering voltage output end according to a set discharge slope to form said chamfering voltage when said second switching circuit is turned on, and wherein said discharge circuit comprises a discharge resistor, and a discharge rate of said discharge resistor is configured so that it can enable the direct voltage received by said direct voltage input end to be reduced to the value of the chamfering voltage within a time period less than or equal to a quarter of a sub pixel charge cycle.

3) In one preferred embodiment of item 1) or item 2) of the present disclosure, a value of said discharge resistor is no more than 500Ω.

4) In one preferred embodiment of any one of item 1) to item 3) of the present disclosure, said discharge circuit further comprises a diode, a cathode thereof being connected with said discharge resistor, and an anode thereof being connected with said second switching circuit.

5) In one preferred embodiment of any one of item 1) to item 4) of the present disclosure, wherein said first switching circuit comprises a first switching transistor, a second switching transistor, a first resistor, and a second resistor; wherein a first end of said second switching transistor is connected with said direct voltage input end, and a second end of said second switching transistor is connected with said chamfering voltage output end; wherein said first resistor and said second resistor are in series connection between said direct voltage input end and a first end of said first switching transistor; wherein a control end of said second switching transistor is connected between said first resistor and said second resistor; wherein a control end of said first switching transistor is used for receiving said first time sequence signal, and a second end of said first switching transistor is connected with the ground; and wherein said first switching transistor is N-type thin film transistor or N-type field effect transistor, and said second switching transistor is P-type thin film transistor or P-type field effect transistor.

6) In one preferred embodiment of any one of item 1) to item 5) of the present disclosure, wherein said second switching circuit comprises a third switching transistor, a first end of said third switching transistor being connected with an end of said discharge circuit, a second end of said third switching transistor being connected with the ground, and a control end of said third switching transistor receiving said second time sequence signal; and wherein said third switching transistor is N-type thin film transistor or N-type field effect transistor.

7) In one preferred embodiment of any one of item 1) to item 6) of the present disclosure, the value of the chamfering voltage generated by said discharge circuit is set to enable a flicker rate of said liquid crystal display panel to be less than or equal to a threshold, so as to maintain a uniformity of said liquid crystal display panel in each region thereof.

8) According to another aspect of the present disclosure, the present disclosure further provides a method for driving a liquid crystal display panel, comprising: during each charge cycle, inputting a direct voltage to a direct voltage input end of a chamfering circuit; inputting a first time sequence signal to a first switching circuit of said chamfering circuit to turn on said first switching circuit, and transmitting the direct voltage received by said direct voltage input end to a chamfering voltage output end; inputting a second time sequence signal to a second switching circuit of said chamfering circuit to turn on said second switching circuit, said second time sequence signal and said first time sequence signal being pulse voltage signals with opposite polarities; reducing, by a discharge circuit of the chamfering circuit, when said second switching circuit is turned on, a direct voltage transmitted to said chamfering voltage output end according to a set discharge slope to form a chamfering voltage, wherein a discharge resistor in said discharge circuit is arranged in such a manner that a discharge rate of said discharge resistor can enable the direct voltage received by said direct voltage input end to be reduced to the value of the chamfering voltage within a time period less than or equal to a quarter of a sub pixel charge cycle.

9) In one preferred embodiment of item 1) of the present disclosure, the value of the chamfering voltage generated by said discharge circuit is configured to enable a flicker rate of said liquid crystal display panel to be less than or equal to a threshold, so as to maintain a uniformity of said liquid crystal display panel in each region.

Compared with the prior art, one embodiment or a plurality of embodiments of the present disclosure may have the following advantages or beneficial effects.

According to the embodiments of the present disclosure, with the close-point voltage VGH(off) at the end of the saturation state of the gate being unchanged, the value of the discharge resistor in the chamfering circuit is reduced, and the duty ratio of the input pulse of the chamfering circuit is regulated so as to reduce the discharge time thereof. By means of which, the discharge rate of the chamfering circuit can be improved, and the charge capacity of the sub pixel can be increased. In this manner, the pixels located at the left end and the right end of the display panel can be charged to reach or close to the target voltage within the effective charge time, so that a flicker of the image can be avoided and the uniformity of the liquid crystal display panel in each region thereof can be improved. Therefore, the display effect at the middle part of the display panel is consistent with the display effect at the left end and the right end of the display panel, and thus the color shift issue of the liquid crystal display panel with Tri-Gate driving structure can be eliminated.

Other features and advantages of the present disclosure will be further explained in the following description, and partially become self-evident therefrom, or be understood through the embodiments of the present disclosure. The objectives and advantages of the present disclosure will be achieved through the structure and/or procedure specifically pointed out in the description, claims, and the accompanying drawings.

### BRIEF DESCRIPTION OF THE DRAWINGS

The accompanying drawings are used for providing further understandings of the present disclosure or the prior art and constitute one part of the description. The drawings, which illustrate the embodiments of the present disclosure, are used for interpreting the present disclosure together with the embodiments, not for limiting the technical solution of the present disclosure.

FIG. 1 schematically shows a liquid crystal display panel with Tri-Gate driving structure in the prior art;

FIG. 2 schematically shows the pixel units;

FIG. 3(a) and FIG. 3(b) schematically show the voltage waveforms of the data line Dn/2 and the data line Dn respectively when the liquid crystal display panel as shown in FIG. 1 is displaying low gray-scale mixed color images;

FIG. 4 schematically shows the structure of a liquid crystal display panel according to an embodiment of the present disclosure;

FIG. 5 schematically shows a chamfering circuit according to the embodiment of the present disclosure;

FIG. 6 schematically shows the waveforms of an input signal and an output signal of the chamfering circuit according to the embodiment of the present disclosure;

FIG. 7 schematically shows the voltage waveform of the data line Dn of the liquid crystal display panel according to the embodiment of the present disclosure; and

FIG. 8 schematically shows the transfer characteristic curve of a switching element.

### DETAILED DESCRIPTION OF THE EMBODIMENTS

The present disclosure will be illustrated in detail hereinafter in combination with the accompanying drawings to make the purpose, technical solutions, and advantages of the present disclosure more clear.

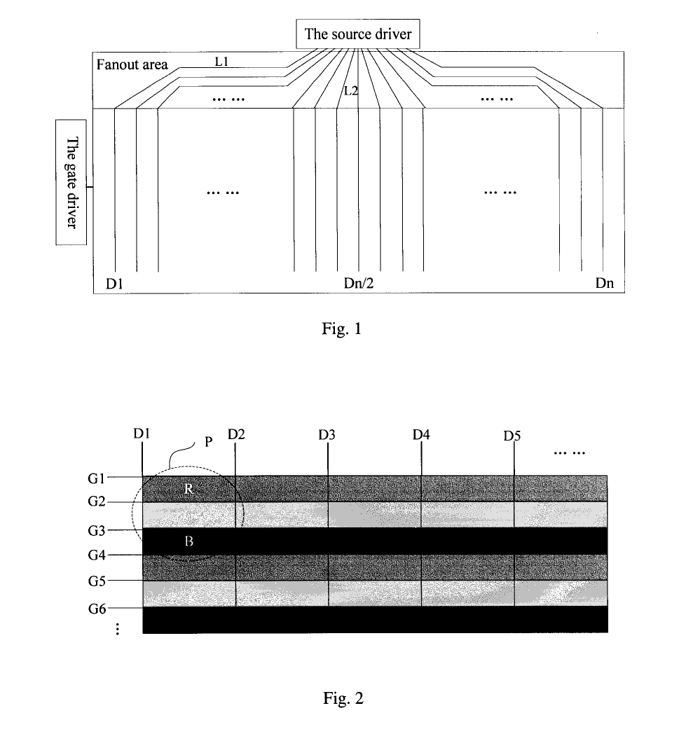

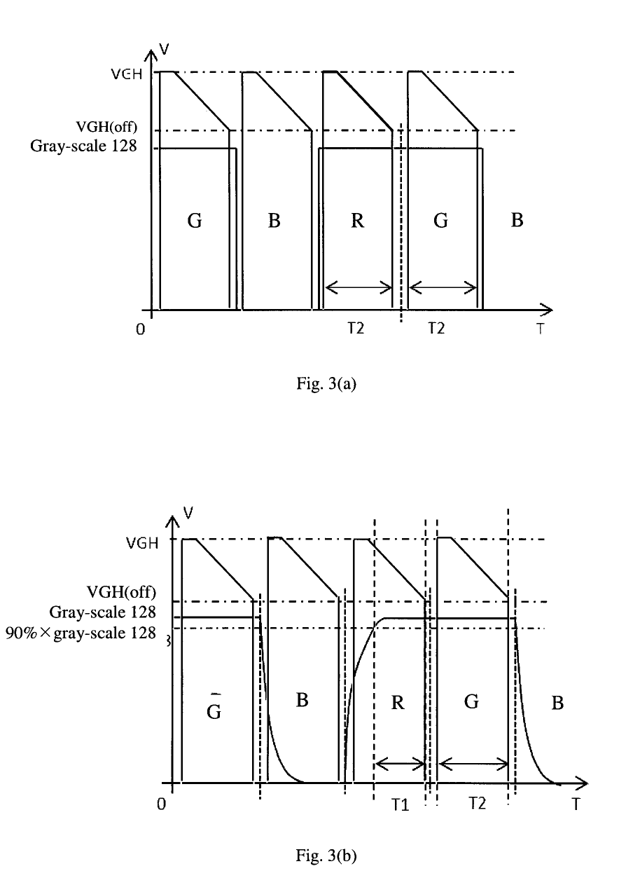

FIG. 3(a) and FIG. 3(b) schematically show the voltage waveforms of the data line Dn/2 (i.e., the data line located at the middle part of the panel) and the data line Dn (i.e., the data line located at the left end or the right end of the panel) respectively when the liquid crystal display panel as shown in FIG. 1 is displaying low gray-scale mixed color images. Here, a yellow image with 128 gray-scales is taken as an example of the low gray-scale mixed color image, and the gray-scales of each hue area, i.e., red (R), green (G), and blue (B), are 128, 128, and 0 respectively.

Reference can be made to FIG. 3(a), wherein VGH represents a gate saturation voltage, and VGH(off) represents a close-point voltage at an end of a saturation state of the gate (i.e., a chamfering voltage), which is a special voltage of the gate saturation voltage. The “gray-scale 128” represents a voltage of a display gray-scale 128. Since the resistance of the WOA of the data line Dn/2 at the middle part of the panel is the smallest, the charging state of the sub pixel corresponding to said data line can be considered as the ideal state, i.e., the charging voltages of the R sub pixel and G sub pixel do not change at all. In addition, the charge time of the R sub pixel is the same as that of the G sub pixel, which can be represented by T2. In this case, the area of the display panel corresponding to the sub pixels would display the expected yellow image, and the color shift phenomenon would not occur.

As shown in FIG. 3(b), “90%×gray-scale 128” represents an effective voltage of the display gray-scale 128, which is 90 percent of the voltage of the display gray-scale 128. Of course, a voltage being larger than 90 percent of the voltage of the display gray-scale 128 also can be selected as the effective voltage. Since the resistance of the WOA of the data line Dn at the left end or right end of the panel is fairly large, the RC delay effect generated therein is relatively obvious. Consequently, the charge voltages of the R sub pixel and the G sub pixel both change. Especially for the R sub pixel, the charge time (i.e., the effective charge time T1 as shown in FIG. 3(b)) thereof decreases greatly due to the RC delay effect. Under such circumstances, the R sub pixel cannot reach the required charge capacity, so that the image displayed in the corresponding area of the display panel would contain more green color ingredient relative to red color ingredient. That is, the color shift phenomenon would occur.

In a word, in the current driving method through which a low gray-scale mixed color image is displayed, for example, the yellow image with 128 gray-scales is displayed, the color shift phenomena would occur, i.e., the display area at the left end or the right end of the liquid crystal display panel would contain more red color ingredient relative to green color ingredient, or more green color ingredient relative to red color ingredient.

It should be noted that, after a display panel is produced, the effective charge time T1 of a sub pixel would not change. In order to improve the charge capacity of the sub pixel, and enable the voltage of the sub pixel to reach or close to a target voltage within a fixed effective charge time, the following embodiment is proposed by the applicant of the present application.

According to the embodiment of the present disclosure, with the close-point voltage VGH(off) at the end of the saturation state of the gate being unchanged, the value of the discharge resistor in the chamfering circuit is reduced, and the starting time and the duty ratio of the input pulse GVON of the chamfering circuit are regulated. By means of which, the discharge rate of the chamfering circuit can be improved, and the charge capacity of the sub pixel can be increased. In this manner, the pixels located at the left end and the right end of the display panel can be charged to reach or close to the target voltage within the effective charge time, so that a flicker of the image can be avoided and the uniformity of the liquid crystal display panel in each region thereof can be improved. Therefore, the display effect at the middle part of the display panel is consistent with the display effect at the left end and the right end of the display panel, and thus the color shift issue of the liquid crystal display panel with Tri-Gate driving structure can be eliminated.

The embodiment of the present disclosure will be illustrated hereinafter.

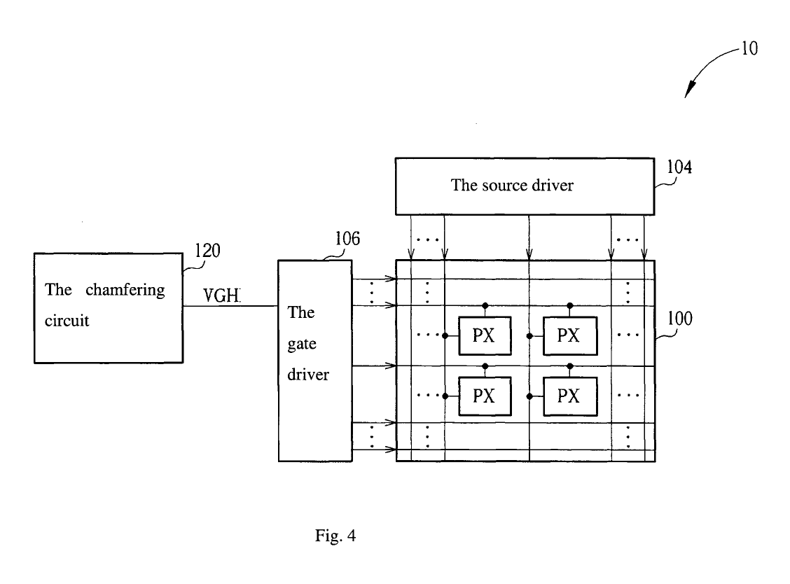

FIG. 4 schematically shows the structure of a liquid crystal display device according to an embodiment of the present disclosure. As shown in FIG. 4, the liquid crystal display device 10 comprises a pixel array unit 100 containing a plurality of pixels PX, a source driver 104, a gate driver 106, and a chamfering circuit 120. The source driver 104 is used for providing a data signal to the pixel array unit 100. The gate driver 106 is used for providing a gate signal to the pixel array unit 100 according to a chamfering voltage VGH(off) provided by the chamfering circuit 120. The pixel array unit 100 is used for displaying an image according to the data signal and the gate signal. The chamfering circuit 120 is electrically connected with the gate driver 106, and configured to reduce a direct voltage received therein to a value of the chamfering voltage within a set time, so as to avoid a flicker of an image and maintain a uniformity of said liquid crystal display panel in each region thereof. The term “uniformity” represents the consistency of the brightness of the panel and the differences thereof, which can be expressed as “the brightness of the darkest point/the brightness of the brightest point”.

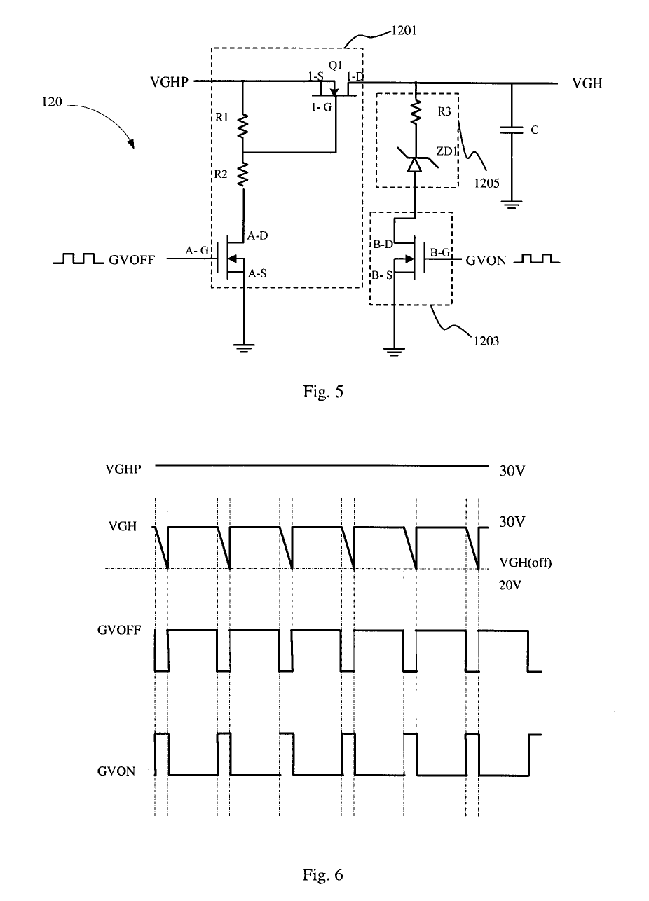

FIG. 5 schematically shows the chamfering circuit 120 according to the embodiment of the present disclosure. As shown in FIG. 5, the chamfering circuit 120 comprises a direct voltage input end VGHP, a chamfering voltage output end VGH, a first switching circuit 1201, a second switching circuit 1203, and a discharge circuit 1205. The first switching circuit 1201, which is connected between said direct voltage input end VGHP and said chamfering voltage output end VGH, is selectively turned on under a control of a first time sequence signal GVOFF, and is used for selectively transmitting a direct voltage received by said direct voltage input end VGHP to said chamfering voltage output end VGH.

The second switching circuit 1203 is connected with the discharge circuit 1205, and is selectively turned on under a control of a second time sequence signal GVON.

The discharge circuit 1205, which is connected between said second switching circuit 1203 and said chamfering voltage output end VGH, is used for reducing a direct voltage transmitted to said chamfering voltage output end VGH according to a set discharge slope to form the chamfering voltage when the second switching circuit 1203 is turned on.

Specifically, the first switching circuit 1201 comprises a switching transistor A, a switching transistor Q1, a resistor R1, and a resistor R2, wherein a first end 1-S of the switching transistor Q1 is connected with the direct voltage input end VGHP, and a second end 1-D of the switching transistor Q1 is connected with the chamfering voltage output end VGH; the resistor R1 and the resistor R2 are in series connection between the direct voltage input end VGHP and a first end A-D of the switching transistor A; a control end 1-G of the switching transistor Q1 is connected between the resistor R1 and the resistor R2; and a control end A-G of the switching transistor A is used for receiving the first time sequence signal GVOFF, and a second end A-S of the switching transistor A is connected with the ground.

According to the present embodiment, the switching transistor Q1 is P-type thin film transistor or P-type field effect transistor, and the first end 1-S, the second end 1-D, and the control end 1-G thereof are a source, a drain, and a gate of the P-type transistor respectively. The switching transistor A is N-type thin film transistor or N-type field effect transistor, and the first end A-D, the second end A-S, and the control end A-G thereof are a drain, a source, and a gate of the N-type transistor respectively.

The second switching circuit 1203 comprises a switching transistor B, a first end B-D of the switching transistor B being connected with an end of the discharge circuit 1205, a second end B-S of the switching transistor B being connected with the ground, and a control end B-G of the switching transistor B receiving the second time sequence signal GVON. According to the present embodiment, the switching transistor B is N-type thin film transistor or N-type field effect transistor, and the first end B-D, the second end B-S, and the control end B-G thereof are a drain, a source, and a gate of the N-type transistor respectively.

It should be noted that, the first time sequence signal GVOFF and the second time sequence signal GVON are both voltage signals but with opposite polarities, which can be generated by a time sequence controller and an inverter. Specifically, the first time sequence signal GVOFF is generated by the time sequence controller, and then inverted into the second time sequence signal GVON by the inverter. The first time sequence signal GVOFF and the second time sequence signal GVON can be generated through other methods in addition to the above method.

Reference can be made to FIG. 5, wherein the discharge circuit 1205 comprises a discharge resistor R3 arranged in series connection therein. A discharge rate of the discharge resistor enables the direct voltage VGHP received by said direct voltage input end VGHP to be reduced to the value of the chamfering voltage VGH within a time period less than or equal to a quarter of a sub pixel charge cycle. Of course, the above discharge time period is just a preferred example, and other discharge time period can be selected by a person skilled in the art in some cases.

It could be understood that, in addition to the P-type and N-type switching transistors of the embodiment of the present disclosure, other simple components which can play the role of switching can also be used in the circuit of other embodiments, such as triode, thyristor, and relay.

In addition, the discharge circuit 1205 may further comprise a Zener diode ZD1 to regulate the voltage thereof. An anode of the Zener diode ZD 1 is connected with the first end B-D of the switching transistor B, and a cathode of the Zener diode ZD1 is connected with the discharge resistor R3. The capacitor C as shown in FIG. 5 represents parasite capacitor of the scanning lines of the display panel.

It should be noted that, the circuit structure of the above chamfering circuit 120 is just an example. The first switching circuit and the second switching circuit can be commutated through a commutation circuit, whereby the function of the chamfering circuit can be realized. Therefore, all other kinds of chamfering circuits, through which the direct voltage received therein can be reduced to the value of the chamfering voltage within a set time, so that the color shift phenomena can be eliminated, fall within the scope of the present disclosure.

FIG. 6 schematically shows the waveforms of an input signal (including the direct voltage VGHP, the first time sequence signal GVOFF, and the second time sequence signal GVON) and an output signal of the chamfering circuit according to the embodiment of the present disclosure. The working principle of the chamfering circuit of the present disclosure will be illustrated in detail hereinafter with reference to FIG. 6.

As shown in FIG. 6, which represents an example of the present embodiment, the duty ratio (the negative voltage) of the second time sequence signal GVON is raised to 80 percent from 23 percent, and the duty ratio (the negative voltage) of the first time sequence signal GVOFF is reduced to 20 percent from 77 percent. Of course, the duty ratio of the time sequence signal can be set as other percentage, as long as the discharge time period thereof is less than or equal to a quarter of a sub pixel charge cycle.

As shown in FIG. 5, during each charge cycle, the direct voltage is input to the direct voltage input end VGHP, the first time sequence signal GVOFF is input to the control end A-G of the switching transistor A of the first switching circuit 1201, and the second time sequence signal GVON is input to the control end B-G of the switching transistor B of the second switching circuit 1203.

When the first time sequence signal GVOFF is in a high-level state, the switching transistors A and Q1 are both turned on. At this moment, the second time sequence signal GVON is in a low-level state, the switching transistor B is turned off, and the voltage output by the chamfering voltage output end VGH is consistent with the voltage of the direct voltage input end VGHP. When the second time sequence signal GVON is in a high-level state, the switching transistor B is turned on, the first time sequence signal GVOFF is in a low-level state, and the switching transistors A and Q1 are both turned off. At this moment, the chamfering voltage is formed by the discharge resistor R3 and output to the chamfering voltage output end VGH. The chamfering voltage can also be generated through controlling the corresponding relationship between the first time sequence signal GVOFF and the second time sequence signal GVON, without the discharge resistor R3 being provided therein.

It should be noted that, in the present embodiment, the value of the discharge resistor R3 is preferably less than or equal to 500Ω. In one example, the value of the discharge resistor R3 is 3360. Since the value of the discharge resistor R3 is far less than the value of the discharge resistor used in the prior art, which is more than 1.5 KΩ in general, the discharge rate of the chamfering circuit can be increased to a large extent. By means of which, the voltage can be reduced to the preset chamfering voltage within a time period of 20 percent of the charge cycle.

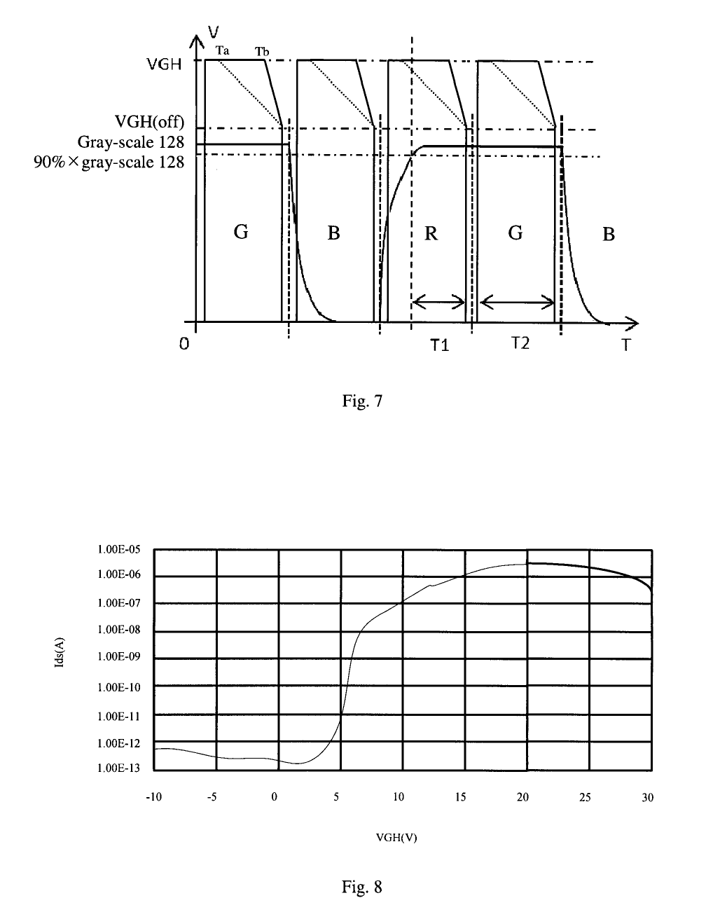

As shown in FIG. 7, the starting time when the discharge circuit 1205 starts to discharge in each cycle is put off to Tb from Ta, whereby the duration of the high-level voltage of the chamfering voltage output end VGH (which is equivalent to the direct voltage VGHP of the direct voltage input end) can be prolonged, and thus the charge capability of the sub pixel can be improved. This is because, for the switching transistor connected with the sub pixel, the gate thereof corresponds to the scanning line, the source thereof corresponds to the data line, and the drain thereof corresponds to the pixel electrode. The pixel of the drain can be charged and discharged by the data line of the source through the switching transistor under the control of the gate. Moreover, the function of the gate is controlling the conductivity of the switching transistor. When the pixel needs to be charged or discharged, the switching transistor works in a saturation state with a large current; and when the pixel does not need to be charged or discharged, the switching transistor works in an off-state with a small current. The large current in the saturation state shoulders the function of charging and discharging, which means that the larger the current is, the faster and the more sufficient the charging and discharging procedure will be.

The result as shown in FIG. 8 is obtained through testing the switching elements of different types. As shown in FIG. 8, with the gradual increase of the chamfering voltage VGH, the saturation current of the switching element connected with the pixel will increase accordingly. Therefore, a relatively high chamfering voltage VGH will be selected in order to improve the charge capacity. In this case, since the charge capacity is improved, the sub pixels can be charged to reach or close to the target voltage within a fixed effective charge time T1. When a low gray-scale mixed color image, for example, the yellow image with 128 gray-scales, is displayed, the color shift phenomena would not occur, i.e., the display area at the left end or the right end of the liquid crystal display panel would not contain more red color ingredient relative to green color ingredient, or more green color ingredient relative to red color ingredient, whereby the display quality thereof can be improved.

In addition, the chamfering voltage (i.e., the gate off-state voltage) is preferably configured to enable a flicker rate of the liquid crystal display panel to be less than or equal to a threshold, and to maintain a uniformity of said liquid crystal display panel in each region thereof, wherein the flicker rate can be expressed as “(the highest brightness-the lowest brightness)/the average brightness”. Taking the liquid crystal display panel with 32 tri-gate as an example, the threshold of the flicker rate is 5, and the uniformity of the panel is higher than 80 percent.

In the present embodiment, the VGH(off) is preferably selected to be 20V, so that the flicker of the image due to the over-high VGH(off), or undesirable colors or noise due to the over-low VGH(off) when the thin film transistor of the panel is turned off can be avoided.

The preferred embodiments of the present disclosure are stated hereinabove, but the protection scope of the present disclosure is not limited by this. Any changes or substitutes readily conceivable for any one skilled in the art within the technical scope disclosed by the present disclosure shall be covered by the protection scope of the present disclosure.

1. A liquid crystal display panel, comprising:
a source driver, used for providing a data signal;
a gate driver, used for providing a gate signal according to a chamfering voltage;
a pixel array, electrically connected between said source driver and said gate driver, and used for displaying an image according to said data signal and said gate signal;
a chamfering circuit, electrically connected with said gate driver, and used for providing said chamfering voltage,
wherein said chamfering circuit is configured to reduce a direct voltage received therein to a value of the chamfering voltage within a set time, so as to avoid a flicker of the image and maintain a uniformity of said liquid crystal display panel in each region thereof.

2. The liquid crystal display panel according to claim 1,
wherein said chamfering circuit comprises:
a direct voltage input end;
a chamfering voltage output end;
a first switching circuit, which is connected between said direct voltage input end and said chamfering voltage output end, and can be selectively turned on under a control of a first time sequence signal to selectively transmit a direct voltage received by said direct voltage input end to said chamfering voltage output end;
a second switching circuit, which can be selectively turned on under a control of a second time sequence signal, said second time sequence signal and said first time sequence signal being pulse voltage signals with opposite polarities;
a discharge circuit, which is connected between said second switching circuit and said chamfering voltage output end, and can be used for reducing a direct voltage transmitted to said chamfering voltage output end according to a set discharge slope to form said chamfering voltage when said second switching circuit is turned on, and
wherein said discharge circuit comprises a discharge resistor, and a discharge rate of said discharge resistor is configured so that it can enable the direct voltage received by said direct voltage input end to be reduced to the value of the chamfering voltage within a time period less than or equal to a quarter of a sub pixel charge cycle.

3. The liquid crystal display panel according to claim 1, wherein a value of said discharge resistor is no more than 500Ω.

4. The liquid crystal display panel according to claim 2, wherein said discharge circuit further comprises a diode, a cathode thereof being connected with said discharge resistor, and an anode thereof being connected with said second switching circuit.

5. The liquid crystal display panel according to claim 2,
wherein said first switching circuit comprises a first switching transistor, a second switching transistor, a first resistor, and a second resistor;
wherein a first end of said second switching transistor is connected with said direct voltage input end, and a second end of said second switching transistor is connected with said chamfering voltage output end;
wherein said first resistor and said second resistor are in series connection between said direct voltage input end and a first end of said first switching transistor;
wherein a control end of said second switching transistor is connected between said first resistor and said second resistor;
wherein a control end of said first switching transistor is used for receiving said first time sequence signal, and a second end of said first switching transistor is connected with the ground; and
wherein said first switching transistor is N-type thin film transistor or N-type field effect transistor, and said second switching transistor is P-type thin film transistor or P-type field effect transistor.

6. The liquid crystal display panel according to claim 3,
wherein said first switching circuit comprises a first switching transistor, a second switching transistor, a first resistor, and a second resistor;
wherein a first end of said second switching transistor is connected with said direct voltage input end, and a second end of said second switching transistor is connected with said chamfering voltage output end;
wherein said first resistor and said second resistor are in series connection between said direct voltage input end and a first end of said first switching transistor;
wherein a control end of said second switching transistor is connected between said first resistor and said second resistor;
wherein a control end of said first switching transistor is used for receiving said first time sequence signal, and a second end of said first switching transistor is connected with the ground; and
wherein said first switching transistor is N-type thin film transistor or N-type field effect transistor, and said second switching transistor is P-type thin film transistor or P-type field effect transistor.

7. The liquid crystal display panel according to claim 4,
wherein said first switching circuit comprises a first switching transistor, a second switching transistor, a first resistor, and a second resistor;
wherein a first end of said second switching transistor is connected with said direct voltage input end, and a second end of said second switching transistor is connected with said chamfering voltage output end;
wherein said first resistor and said second resistor are in series connection between said direct voltage input end and a first end of said first switching transistor;
wherein a control end of said second switching transistor is connected between said first resistor and said second resistor;
wherein a control end of said first switching transistor is used for receiving said first time sequence signal, and a second end of said first switching transistor is connected with the ground; and
wherein said first switching transistor is N-type thin film transistor or N-type field effect transistor, and said second switching transistor is P-type thin film transistor or P-type field effect transistor.

8. The liquid crystal display panel according to claim 2,
wherein said second switching circuit comprises a third switching transistor, a first end of said third switching transistor being connected with an end of said discharge circuit, a second end of said third switching transistor being connected with the ground, and a control end of said third switching transistor receiving said second time sequence signal; and
wherein said third switching transistor is N-type thin film transistor or N-type field effect transistor.

9. The liquid crystal display panel according to claim 3,
wherein said second switching circuit comprises a third switching transistor, a first end of said third switching transistor being connected with an end of said discharge circuit, a second end of said third switching transistor being connected with the ground, and a control end of said third switching transistor receiving said second time sequence signal; and
wherein said third switching transistor is N-type thin film transistor or N-type field effect transistor.

10. The liquid crystal display panel according to claim 4,
wherein said second switching circuit comprises a third switching transistor, a first end of said third switching transistor being connected with an end of said discharge circuit, a second end of said third switching transistor being connected with the ground, and a control end of said third switching transistor receiving said second time sequence signal; and
wherein said third switching transistor is N-type thin film transistor or N-type field effect transistor.

11. The liquid crystal display panel according to claim 1, wherein the value of the chamfering voltage generated by said discharge circuit is set to enable a flicker rate of said liquid crystal display panel to be less than or equal to a threshold, so as to maintain a uniformity of said liquid crystal display panel in each region thereof.

12. A method for driving a liquid crystal display panel, comprising:
during each charge cycle,
inputting a direct voltage to a direct voltage input end of a chamfering circuit;
inputting a first time sequence signal to a first switching circuit of said chamfering circuit to turn on said first switching circuit, and transmitting the direct voltage received by said direct voltage input end to a chamfering voltage output end;
inputting a second time sequence signal to a second switching circuit of said chamfering circuit to turn on said second switching circuit, said second time sequence signal and said first time sequence signal being pulse voltage signals with opposite polarities;
reducing, by a discharge circuit of the chamfering circuit, when said second switching circuit is turned on, a direct voltage transmitted to said chamfering voltage output end according to a set discharge slope to form a chamfering voltage,
wherein a discharge resistor in said discharge circuit is arranged in such a manner that a discharge rate of said discharge resistor can enable the direct voltage received by said direct voltage input end to be reduced to the value of the chamfering voltage within a time period less than or equal to a quarter of a sub pixel charge cycle.

13. The method according to claim 12, wherein the value of the chamfering voltage generated by said discharge circuit is configured to enable a flicker rate of said liquid crystal display panel to be less than or equal to a threshold, so as to maintain a uniformity of said liquid crystal display panel in each region.
